(19) United States
(12) Patent Application Publication
(10) Pub. No.: US 2012/0043479 A1
(43) Pub. Date: Feb. 23, 2012

(54) Normalization of Biomolecules

(75) Inventors: Chandra-Shekara A. Channabasavaradhya, Westfield, IN (US); Zoe C. Ehlert, Saskatoon (CA); Jennifer C. Mingus, Zionsville, IN (US); Annette R. Thom, Mooresville, IN (US)

(73) Assignee: Dow AgroSciences LLC., Indianapolis, IN (US)

(21) Appl. No.: 13/205,436

(22) Filed: Aug. 8, 2011

Related U.S. Application Data
(60) Provisional application No. 61/374,535, filed on Aug. 17, 2010.

(51) Int. Cl. G01N 21/64

(52) U.S. Cl. 250/459.1; 250/458.1

(57) ABSTRACT

The present disclosure provides systems and methods for normalization of multiple samples, including DNA samples. The subject invention allows for decreased human error, decreased ergonomic concerns, and an increase in throughput. The subject invention provides systems and methods that allow for automated normalization of samples in multi-well plates. According to the present disclosure, a method for normalizing samples is provided. Some preferred methods comprise determining florescence data of one or more wells on a plate; electronically, using a processor, calculating dilution data for one or more of the wells on the plate based at least in part on the florescence data; and adding a liquid to the one or more wells on the plate based at least in part on the dilution data.

### CROSS REFERENCE TO RELATED APPLICATIONS

This application claims priority to U.S. Provisional Patent Application No. 61/374,535, filed Aug. 17, 2010, the entire disclosure of which is incorporated by reference.

### FIELD OF THE DISCLOSURE

The present disclosure relates in part to normalization of biomolecular components such as DNA, RNA, protein, starch and lipids concentrations. More particularly, the present disclosure relates in part to the processing and normalization of multiple samples, including DNA samples.

### BACKGROUND OF THE DISCLOSURE

Accurate quantification and normalization of biomolecular components is important for further analysis of the samples. For example, quantification and normalization of genomic DNA from tissue samples is important for, for example, conducting DNA based analyses used in sequencing, southern analysis, marker assisted breeding, zygosity testing, and adventitious presence testing. Manual normalization of DNA samples may be time consuming, and may be a bottle neck in a laboratory testing DNA samples. In a 96-well plate, 96 samples may need to be analyzed and normalized, so that the samples are each within a range of concentration for proper analysis. Accidentally normalizing the wrong well or contaminating a well is a possibility when normalizing DNA manually, leading to errors and additional work to re-run the samples.

### SUMMARY

The present disclosure provides systems and methods for normalization of multiple samples, including DNA samples.

The subject invention allows for decreased human error, decreased ergonomic concerns, and an increase in throughput. The subject invention provides systems and methods that allow for automated normalization of samples in multi-well plates.

According to the present disclosure, a method for normalizing samples is provided. Some preferred methods comprise determining florescence data of one or more wells on a plate; electronically, using a processor, calculating dilution data for one or more of the wells on the plate based at least in part on the florescence data; and adding a liquid to the one or more wells on the plate based at least in part on the dilution data.

Additional features and advantages of the present disclosure will become apparent to those skilled in the art upon consideration of the following detailed description of the illustrative embodiments exemplifying the best mode of carrying out the invention.

### BRIEF DESCRIPTION OF THE DRAWINGS

The detailed description of the drawings particularly refers to the accompanying figures in which:

FIG. 1 is a component view of an exemplary normalizing system according to an embodiment of the present disclosure;

FIG. 2 is a component view of the normalization system 107 of FIG. 1 according to an embodiment of the present disclosure;

FIG. 3 is a flowchart showing a method of normalizing samples according to an embodiment of the present disclosure;

FIG. 4 is an exemplary representation of a 96-well plate, showing three conditions according to an embodiment of the present disclosure;

FIG. 5 is an exemplary input dataset according to an embodiment of the present disclosure;

FIG. 6 is an exemplary output dataset according to an embodiment of the present disclosure; and

FIG. 7 is an exemplary view of settings for customization of the normalization calculations according to an embodiment of the present disclosure.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations of a normalization system 107, it should be understood that the concepts presented herein may be used in other various configurations consistent with this disclosure.

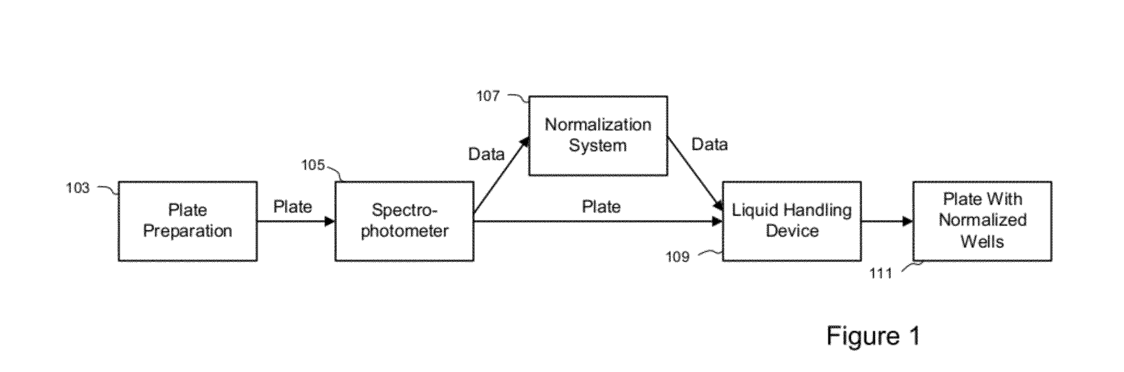

FIG. 1 shows a component view of an exemplary normalizing system according to an embodiment of the present disclosure.

A plate may be prepared shown in box 103. The plate may contain a number of wells, and one or more samples may be disposed in each of the wells. The samples may be any type of biomolecular component such as, for example and without limitation, one or more DNA samples, and may be prepared according to any known methods or practices. In one embodiment, the plate is placed into or provided to a spectrophotometer 105, although any type of machine or process to provide an analysis of a sample may be used. In one embodiment, the spectrophotometer 105 may be a Spectra Max GEMINIS XS microplate fluorometer from Molecular Devices (Sunnyvale, Calif.). The spectrophotometer 105 shines light of any spectrum or spectrums onto the plate, or onto one or more wells of the plate. The light is transmitted through the sample and to a photodetector or other measurement instrument, where the samples florescence is measured. The spectrophotometer 105 may perform additional calculations to determine, for example and without limitation, the concentration of one or more components of the sample. The spectrophotometer 105 may produce data. The data may be in the form of, for example and without limitation, well location information, florescence information corresponding to the well location, or other calculations related to the florescence information. The plate may be removed from the spectrophotometer 105.

The data from the spectrophotometer may be provided to the normalization system 107. The data may be provided by a network or a dedicated connection between the spectrophotometer and the normalization system 107, or by a removable storage from the spectrophotometer to the normalization system 107. In another embodiment, the spectrophotometer may print the data to a screen or to a printer, and the data may be input into the normalization system 107 from, for example and without limitation, a keyboard or a scanner.

The normalization system 107 may receive the data from the spectrophotometer, and may calculate dilution data for all or a portion of the wells of the plate based at least in part on the data received from the spectrophotometer. The dilution data may indicate how much liquid to add to the wells to allow for a consistent concentration between the samples. The normalization system 107 may provide the dilution data to the liquid handling device 109. The data may be provided by a network or a dedicated connection between the normalization system 107 and the liquid handling device 109, or by a removable storage from the normalization system 107 to the liquid handing device. In another embodiment, the normalization system 107 may print the data to a screen or to a printer, and the data may be input into the liquid handing device from, for example and without limitation, a keyboard or a scanner.

The liquid handling device 109, or liquid handler, may accept the plate, and may receive the dilution data from the normalization system 107. The liquid handling device 109 may dispense liquid into the wells of the plate according to the dilution data provided by the normalization system 107. The wells in the plate may, through the selective addition of additional liquid, be normalized across the plate or across one or more of the wells of the plate. The plate may then be removed from the normalization system 107, shown in box 111.

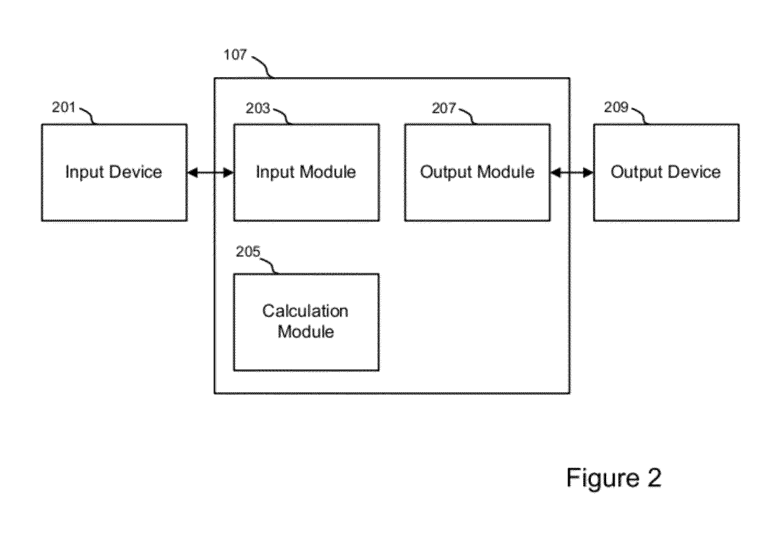

FIG. 2 shows a component view of the normalization system 107 of FIG. 1 according to an embodiment of the present disclosure. The normalization system 107 may include an input module 203, a calculation module 205, and an output module 207. The normalization system 107 may be a single system, or may be two or more systems in communication with each other. The normalization system 107 may include one or more input devices, one or more output devices, one or more processors, and memory associated with the one or more processors. The memory associated with the one or more processors may include, but is not limited to, memory associated with the execution of the modules, and memory associated with the storage of data. The normalization system 107 may also be associated with one or more networks, and may communicate with one or more additional systems via the one or more networks. The modules may be implemented in hardware or software, or a combination of hardware and software. The normalization system 107 may also include additional hardware and/or software to allow the normalization system 107 to access the input devices, the output devices, the processors, the memory, and the modules. The modules, or a combination of the modules, may be associated with a different processor and/or memory, for example on distinct systems, and the systems may be located separately from one another. In one embodiment, the modules may be executed on the same system as one or more processes or services. The modules may be operable to communicate with one another and to share information. Although the modules are described as separate and distinct from one another, the functions of two or more modules may instead be executed in the same process, or in the same system.

The input module 203 may receive data from an input device 201. The input module 203 may also receive input over a network from another system. For example, and without limitation, the input module 203 may receive one or more signals from a computer over one or more networks. The input module 203 may receive data from the input device 201, and may rearrange or reprocess the data so that it may be transmitted to the calculation module 205.

The input device 201 may communicate with the input module 203 via a dedicated connection or any other type of connection. For example, and without limitation, the input device 201 may be in communication with the input module 203 via a Universal Serial Bus (“USB”) connection, via a serial or parallel connection to the input module 203, or via an optical or radio link to the input module 203. The transmission may also occur via one or more physical objects. For example, the spectrophotometer may generate one or more files, and may copy the one or more files to a removable storage device, such as a USB storage device or a hard drive, and a user may remove the removable storage device from the normalization system 107 and attach it to the input module 203 of the normalization system 107. Any communications protocol may be used to communicate between the input device 201 and the input module 203. For example, and without limitation, a USB protocol or a Bluetooth protocol may be used.

In one embodiment, the input device 201 may be a spectrophotometer. The spectrophotometer may analyze a plate and produce florescence data regarding one or more samples within wells on the plate. The data may be in the form of one or more files, or the spectrophotometer may print the data to a screen or a printer, and the data may be input into the normalization system 107 by, for example and without limitation, a keyboard, mouse, or scanner.

The network may include one or more of: a local area network, a wide area network, a radio network such as a radio network using an IEEE 802.11x communications protocol, a cable network, a fiber network or other optical network, a token ring network, or any other kind of packet-switched network may be used. The network may include the Internet, or may include any other type of public or private network. The use of the term “network” does not limit the network to a single style or type of network, or imply that one network is used. A combination of networks of any communications protocol or type may be used. For example, two or more packet-switched networks may be used, or a packet-switched network may be in communication with a radio network.

The calculation module 205 may receive inputs from the input module 203, and may perform one or more calculations on the inputs. For example, and without limitation, the calculation module 205 may calculate the amount of liquid, if any, to be provided to each of the one or more wells on a plate. The calculation may be based on the florescence of each of the samples in the wells on the plate, or may be based on another calculated number from a spectrophotometer. For example, the spectrophotometer may calculate the concentration of the sample based on the florescence, and the calculation module 205 may use the concentration information to determine the amount of liquid, if any, to be provided to the well. One set of calculations may be based on the concentration calculated by the spectrophotometer.

For example, in one exemplary embodiment, a concentration of DNA of 5 ng/μL may be desired for the samples within each of the wells on a plate. If the concentration of a sample in a particular well is less than 5 ng/μL, then the sample may be properly diluted or overdiluted, and the system may not add additional liquid to the well containing the sample. The system may assign the value of liquid to be added to be zero microliters. If the concentration of the sample is greater than or equal to 200 ng/μL, liquid may be added to the maximum physical size of the well. The system may assign the value of liquid to be added to be 199 microliters, if the well on the plate can hold more than 200 microliters of liquid. If the concentration of the sample is between 5 and 200 ng/μL, the amount of liquid may be calculated according to the formula: (200*concentration in ng/μL)/5−200, to yield an amount of liquid to be added to the sample in microliters. Different calculations may be used if different concentrations are desired, or if the wells of the plate have a different total volume. The use of DNA is exemplary only, and other biomolecular components may be analyzed and/or processed.

Sample Visual Basic Code is as follows (code for user form):

```
Sub Norm _Macro( )
‘
‘ Norm _Macro Macro
‘ Macro recorded 8/18/2009 by Annette R. Thom
‘
‘ Keyboard Shortcut: Ctrl+f
‘
filetoopen = Application _{—}
  .GetOpenFilename(“Exce 1 Files (*.xls), *.xls”)
If filetoopen <> False Then
Dim FileName As String
FileName = Left(filetoopen, Len(filetoopen) − 4)
FileName = FileName & “.csv”
Workbooks.Open (filetoopen)
Sheets(“Sheet1 ”).Select Range(“B 1 7”).Select
Range(Selection, Selection.End(xlDown)). Select Selection.Copy
Sheets(“ Sheet2”).Select Range(“B 1 ”).Select
ActiveSheet.Paste
Sheets(“Sheet1 ”).Select ActiveWindow. SmallScroll Down:=−66
Range(“D1 7”). Select
Range(Selection, Selection.End(xlDown)). Select
Application.CutCopyMode = False Selection.Copy
Sheets(“ Sheet2”) .Select Range(“C1 ”).Select
ActiveSheet.Paste
Range(“A1 ”).Select
Application.CutCopyMode = False
ActiveCell.FormulaR1C1 = “Source ”
Range(“A2”). Select ActiveCell.FormulaR 1C1 = “1”
Selection.AutoFill Destination:=Range(“A2 :A93”)
Range(“A2 :A93 ”). Select
Range(“D 1 ”).Select
ActiveCell.FormulaR 1C1 = “H20”
Range(“D2”). Select
  Application.Window State = xlNormal
  ActiveCell.FormulaR1C1 = _{—}
    “=IF(RC[− 1 ]<5,0,IF(((200*RC[−1 ])/
    5)−200>200,200,(200*RC[−1 ]/5)−200))”
  Range(“D2”). Select
  Selection.AutoFill Destination:=Range(“D2 :D93”)
  Range(“D2:D93 ”). Select
  Range(“D2”). Select
  Application.DisplayAlerts = False Sheets(“ Sheet3 ”). Select
  ActiveWindow.SelectedSheets.Delete Sheets(“Sheet1 ”).Select
  ActiveWindow.SelectedSheets.Delete ActiveWorkbook. SaveAs
  FileName, xl CSV
  ActiveWorkbook.Close False
  Application.DisplayAlerts = True
  Application.Quit
End If
End Sub
```

The output module 207 may receive an input, and may transmit the input to an output device 209. In one embodiment, the output module 207 may receive the input from the calculation module 205 in the form of alphanumeric data, and may transmit the data to the output device 209. The output module 207 and the output device 209 may be in communication with one another. For example, and without limitation, the output module 207 and the output device 209 may be in communication via a network, or may be in communication via a dedicated connection, such as a cable or radio link. The output module 207 may also reformat the data received from the calculation module 205 into a format usable by the output device 209. For example, the output module 207 may create one or more files that may be read by the output device 209. In one embodiment, the output module 207 may reformat the data into one or more electronic files readable by Biomek® software, or other software suitable for creating or storing data.

The output device 209 may, in one embodiment, be a liquid handling device 109. In one embodiment, the liquid handling device 109 may be a Biomek® NXp liquid handling device 109 or another device suitable for handling or delivering liquids. The output module 207 may communicate with the liquid handling device 109 by transmitting one or more electronic files to the liquid handling device 109. The transmission may occur over a dedicated link, for example a USB connection or a serial connection, or may occur over one or more network connections. The transmission may also occur via one or more physical objects. For example, the output module 207 may generate one or more files, and may copy the one or more files to a removable storage device, such as a USB storage device or a hard drive, and a user may remove the removable storage device from the normalization system 107 and attach it to the liquid handing device.

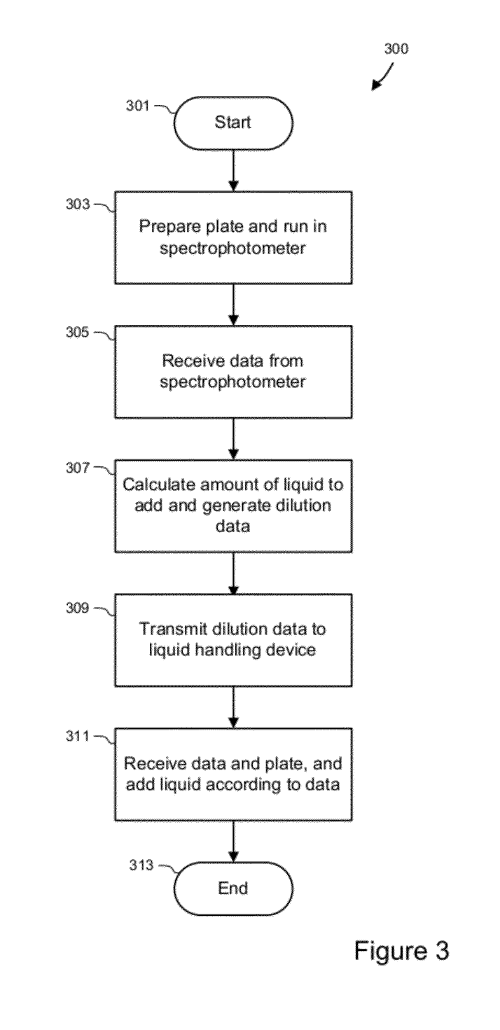

Turning now to FIG. 3, a flowchart showing a method 300 of normalizing samples is shown according to an embodiment of the present disclosure. The method may begin in step 301. As represented in step 303, a plate may be prepared. The plate may contain one or more wells, and each of the wells may contain a different sample. The plate may be analyzed with a spectrophotometer 105. The spectrophotometer 105 may be of any type, and may analyze the samples in the wells of the plate to determine florescence. The spectrophotometer 105 may analyze each sample individually by analyzing each of the one or more wells of the plate individually, or the spectrophotometer may analyze one or more samples simultaneously. The spectrophotometer 105 may record data regarding the sample, such as well location, florescence information, and data that may identify the plate uniquely or may uniquely identify the test of the plate or any of the samples in the wells on the plate. The spectrophotometer 105 may also perform one or more calculations to create additional data based on the florescence information.

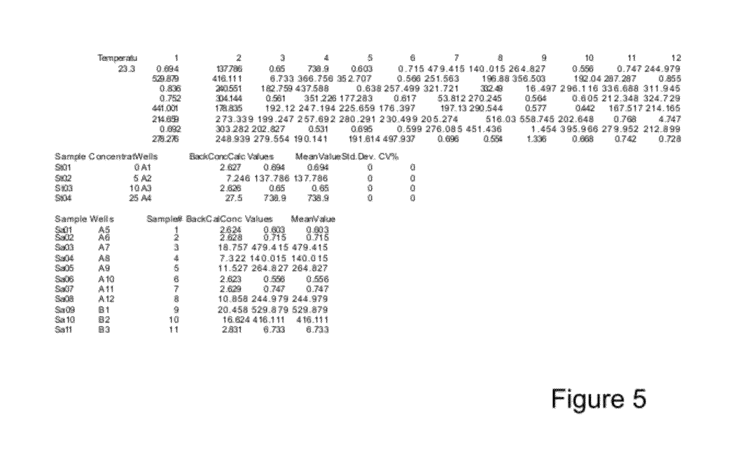

As represented in step 305, the input module 203 of the normalization system 107 may receive the data from the spectrophotometer 105. The normalization system 107 may receive the data from the spectrophotometer 105 when the spectrophotometer 105 transmits the data to the normalization system 107, such as over a network or other data transmission medium. The normalization system 107 and/or the input module 203 may reconfigure or rearrange the data received from the spectrophotometer 105 to perform additional calculations and transmit the data to the liquid handling device 109. An exemplary set of data for a sample plate received from a spectrophotometer is shown in FIG. 5. In FIG. 5, the column “BackCalConc” may be used to calculate the additional liquid, if any, to be added to each well in the plate.

As represented in step 307, the calculation module 205 of the normalization system 107 may calculate dilution data. The dilution data may be calculated based at least in part on the data received from the spectrophotometer 105. For example, the florescence data from the spectrophotometer 105 for each of the wells on the plate may be used to calculate an additional amount of liquid to be added to the wells in order to normalize the concentration of DNA in each of the wells, or of one or more of the wells of the plate.

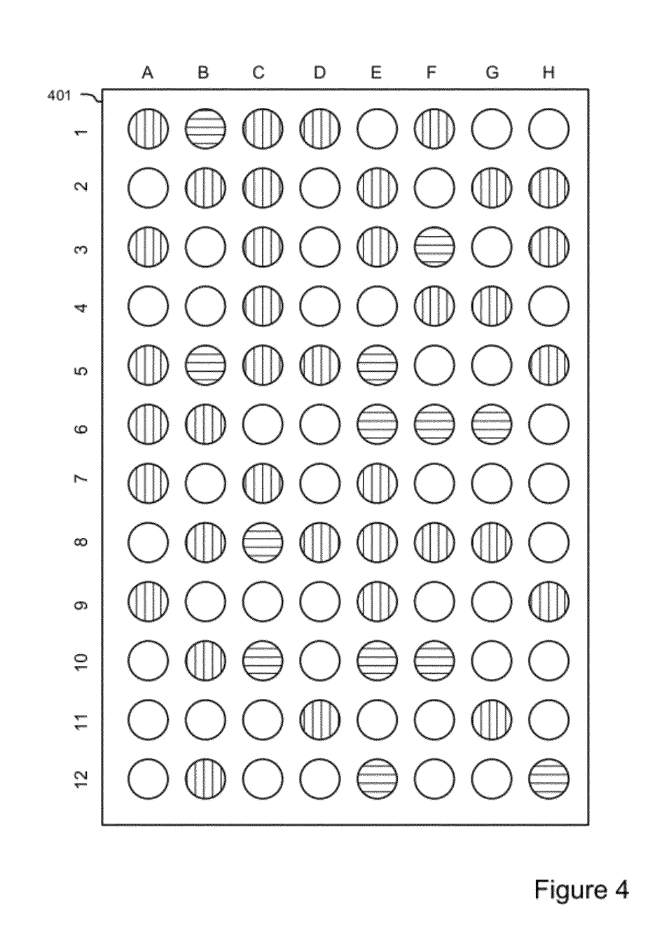

In the exemplary 96 well plate 401 shown in FIG. 4, samples in wells that are appropriately diluted may be represented by horizontal lines, represented by wells b1, b5, c8, c9, e5, e6, e10, e12, f3, f6, f10, g6, and h12. Samples in wells that receive 199 microliters of liquid are represented by vertical lines, represented by wells a1, a3, a5, a6, a7, a9, b2, b6, b8, b10, b12, c1, c2, c3, c4, c5, c7, d1, d5, d8, d11, e2, e3, e7, e8, e9, f1, f4, f8, g2, g4, g8, g11, h2, h3, h5, and h9. The remainder of the wells that have neither horizontal nor vertical markings may represent the wells that may receive a variable amount of liquid according to the calculations provided above with respect to the calculation module 205.

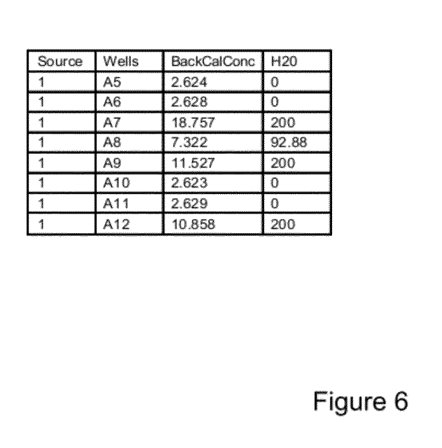

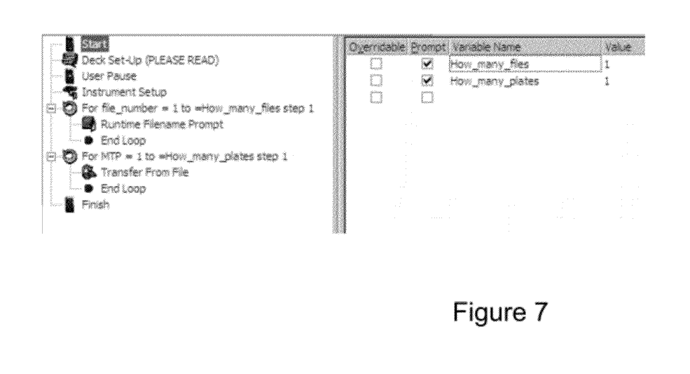

The calculation module 205 may determine an amount of liquid to be added to each of the wells on the plate, and may output the dilution data to the output module 207. The output module 207 may transmit the dilution data to the liquid handling device 109, as represented in step 309. Sample dilution data from the exemplary data received from the spectrophotometer 105 in FIG. 5 is shown as FIG. 6. In FIG. 6, the well identification information and the “BackCalConc” data from FIG. 5 is provided, as well as a determination of an amount of water to be added to each of the wells. The determination may be made by the calculation module 205 according to one or more formulas provided in the calculation module 205. Additional exemplary variables for the calculation module may be shown in FIG. 7. The additional variables may allow a user to select one or more of the wells to calculate, or may allow the user to repeat the method for additional plates, so that many plates may be processed sequentially by the normalization system 107.

As represented in step 311, the liquid handling device 109 may receive the dilution data, and also the plate prepared as represented in step 703 and read by the spectrophotometer 105. The dilution data may be transmitted from the output module 207 of the normalization system 107 by, for example and without limitation, a dedicated connection or a network, or through physical media. The liquid handling device 109 may read the dilution data, and may add an amount of liquid to each of the wells of the plate, or one or more wells of the plate, based on the values transmitted in the dilution data. The liquid handling device 109 may also be programmed with the maximum volume of the wells of the plate, or the liquid handling device 109 may determine the maximum volume of the wells of the plate by, for example and without limitation, determining the size of the plate or using a camera to determine the size of the plate or of the wells. The liquid handling device 109 may not add more liquid to a particular well than the well's maximum volume. The plate may then be removed from the liquid handling device 109, and the normalized plate may then be analyzed further. The method may then end, as represented in step 713.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains and which fall within the limits of the appended claims.

What is claimed is:

1. A method for normalizing samples, the method comprising:
determining florescence data of one or more wells on a plate, with at least one well containing at least one sample;
electronically, using a processor, calculating dilution data for one or more of the wells on the plate based at least in part on the florescence data; and
adding a liquid to the one or more wells on the plate based at least in part on the dilution data.

2. The method of claim 2, wherein the at least one sample comprises at least one biomolecule.

3. The method of claim 3, wherein the at least one biomolecule is selected from the group consisting of DNA, RNA, protein, starch, and lipids.

4. The method of claim 1, wherein the liquid is added to the one or more wells on the plate with a liquid handling device.

5. The method of claim 1, wherein the florescence data is determined using a spectrophotometer.

6. A system for normalizing samples, comprising:
an input module for receiving florescence data of one or more wells on a plate, the one or more wells containing one or more samples;
a calculation module for electronically calculating dilution data for one or more of the wells on the plate based at least in part on the florescence data; and
an output module for transmitting the dilution data.

7. The system of claim 6, further comprising a liquid handling device.

8. The system of claim 7, wherein the liquid handling device receives the dilution data from the output module.

9. The system of claim 8, wherein the liquid handling device adds a liquid to one or more of the wells on the plate based at least in part on the dilution data.

10. The system of claim 6, wherein the florescence data is received via a network.

11. The system of claim 6, wherein the dilution data is transmitted via a network.
